(19) United States
(12) Patent Application Publication
(10) Pub. No.: US 2007/0084063 A1
(43) Pub. Date: Apr. 19, 2007

(54) Kitchen utensil with head supporting member

(75) Inventor: W. Scott Hughes, Chicago, IL (US)

Correspondence Address: LEMPIA FORMAN LLC, 223 W. JACKSON BLVD., SUITE 620, CHICAGO, IL, 60606, US

(73) Assignee: Rubbermaid Incorporated, Huntersville, NC (US)

(21) Appl. No.: 11/595,076

(22) Filed: Nov. 9, 2006

Related U.S. Application Data
(62) Division of application No. 10/891,661, filed on Jul. 15, 2004.
(60) Provisional application No. 60/493,164, filed on Aug. 7, 2003.

(51) Int. Cl. A47J 43/28

(52) U.S. Cl. 30/298.4; 30/327

(57) ABSTRACT

A kitchen utensil has a handle and a utensil head connected to the handle. A supporting member is integrally formed as a part of the handle and is positioned relative to the handle and the head to support the head above a work surface when the utensil is resting on the work surface with the supporting member borne against the work surface. This eliminates the need to use a “spoon rest,” a plate, or a napkin for preventing the utensil from engaging the work surface and/or from dripping contents from the utensil onto the work surface.

### RELATED APPLICATION DATA

This patent is a division of U.S. patent application Ser. No. 10/891,661, which was filed on Jul. 15, 2004 and which claimed priority benefit of U.S. Provisional Application Ser. No. 60/493,164, which was filed on Aug. 7, 2003.

### BACKGROUND

1. Field of the Invention

The present disclosure is generally directed to storage containers, and more particularly to a storage container system that includes various sized containers with universal lids with snap features so that the lids and containers may be snapped together in various configurations either during use or during non-use.

Improved kitchen utensils are disclosed that include integrally connected supporting members that maintain the head of the utensil in a raised position above a horizontal counter when the utensil is placed on a counter thereby eliminating the need for a conventional spoon rest. The disclosed utensils with supporting members are not limited to spoons, but are applicable to various types of kitchen utensils such as ice cream scoops, whisks, forks, spatulas, tongs, turners, etc.

2. Description of the Related Art

One problem associated with common cooking utensils is providing a sanitary place to store the utensil between uses during a single cooking session or operation. Specifically, to avoid contamination from a non-sterile surface or countertop, consumers are wary about resting a cooking utensil directly on a kitchen countertop between uses during a cooking operation. Consumers are concerned that countertops may become contaminated and transfer that contamination to the cooking utensil, which would then make contact with the food under preparation. Further, after using strong cleaning chemicals on a kitchen countertop to maintain sanitization thereof, consumers are wary about contacting a cooking utensil with the countertop which then could result in transfer of cleaning chemicals to the food under preparation.

Thus, consumers do not want to have to clean kitchen utensils during a single cooking process or operation when the utensil is going to be reused and, further, consumers do not want to have to place a dirty cooking utensil on a clean countertop thereby transferring cooking fluids or food material onto the countertop. Finally, consumers do not want to transfer any residual cleaning agents that may be disposed on the countertop to the food under preparation by way of the utensil.

One solution to this problem is to use a clean plate or “spoon rest” upon which the head portion of the dirty utensil is placed. However, this solution creates yet another article to be cleaned (i.e., the spoon rest or plate) and also consumes counter space which may be needed for other uses.

### SUMMARY OF THE DISCLOSURE

In satisfaction of the needs described above, an approved kitchen utensil is disclosed which includes an integral support member that supports the head of the utensil above a horizontal work surface, such as a kitchen counter top, when the utensil is laid to rest on the horizontal surface. More specifically, a disclosed kitchen utensil includes a head, such as a spoon, scoop, whisk, fork or other cooking device, connected to a handle. An integrally connected supporting member is connected to either the handle, the head or separate connecting element which connects the head to the handle. When the utensil is laid down onto a horizontal surface, the supporting member supports the head (i.e. the part of the utensil that makes contact with the food) above the work surface while a portion of the handle and the supporting member rests upon the work surface to provide a stable foundation for supporting the head of the utensil above the work surface.

As a result, the head of the utensil avoids any contact with the work surface thereby addressing the problems discussed above. The utensil may be a spoon, fork, whisk, ice cream scoop or other common kitchen utensil. The supporting member may be integrally connected to any portion of the utensil disposed between the head and the distal end of he handle so that when the supporting member engages the horizontal work surface, the weight of the handle causes at least a distal portion of the handle to also engage the work surface and so that the head of the utensil is supported above and not in engagement with the work surface.

### BRIEF DESCRIPTION OF THE DRAWINGS

Other features and advantages of the disclosed products will become apparent upon reading the following detailed description in conjunction with the accompanying drawings, wherein:

FIG. 1 is a side plan view of an improved spoon equipped with a support made in accordance with this disclosure which maintains the spoon head above a counter surface in a resting position;

FIG. 2 is another side plan view of the spoon shown in FIG. 1;

FIG. 3 is a top plan view of the spoon shown in FIGS. 1 and 2;

FIG. 4 is a side plan view of the spoon and support portion of the assemblies shown in FIGS. 1 and 3 removed from the handle portion (not shown in FIG. 4);

FIG. 5 is a side plan view of an ice cream scoop made in accordance with this disclosure which includes a support member for maintaining the scoop or head portion above the counter surface when in a resting position;

FIG. 6 is another side plan view of a the ice cream scoop shown in FIG. 5;

FIG. 6A is a sectional view taken substantially along line 6A-6A of FIG. 6;

FIG. 7 is a top plan view of the ice cream scoop shown in FIGS. 5 and 6;

FIG. 8 is a side plan view of the scoop or head portion of the ice cream scoop shown in FIGS. 5-7, as detached from the handle portion (not shown in FIG. 8);

FIG. 9 is a top plan view of a whisk made in accordance with this disclosure;

FIG. 10 is a side plan view of the whisk shown in FIG. 9;

FIG. 10A is a sectional view of taken substantially along line 10A-10A of FIG. 10;

FIG. 11 is a top plan view of the whisk or head portion of the whisk shown in FIGS. 9-10 as removed from the handle portion (not shown in FIG. 11);

FIG. 12 is a side plan view of the whisk or head portion as shown in FIG. 11;

FIG. 13 is a side plan view of yet another whisk made in accordance with this disclosure illustrating the support member maintaining the whisk or head portion above the counter surface when in the resting position; and

FIG. 14 is a side plan view of yet another whisk made in accordance with this disclosure illustrating the support member maintaining the whisk or head portion above the counter surface when in the resting position.

### DETAILED DESCRIPTION OF THE PRESENTLY PREFERRED EMBODIMENTS

The present disclosure is directed toward kitchen utensils with an integral supporting member for maintaining the head or utensil portion of the structure above the surface of a countertop or other supporting surface when the utensil is placed in a resting position. The disclosed embodiments eliminate the need for a separate plate or spoon rest for preventing contact between the utensil head and a countertop or other work surface.

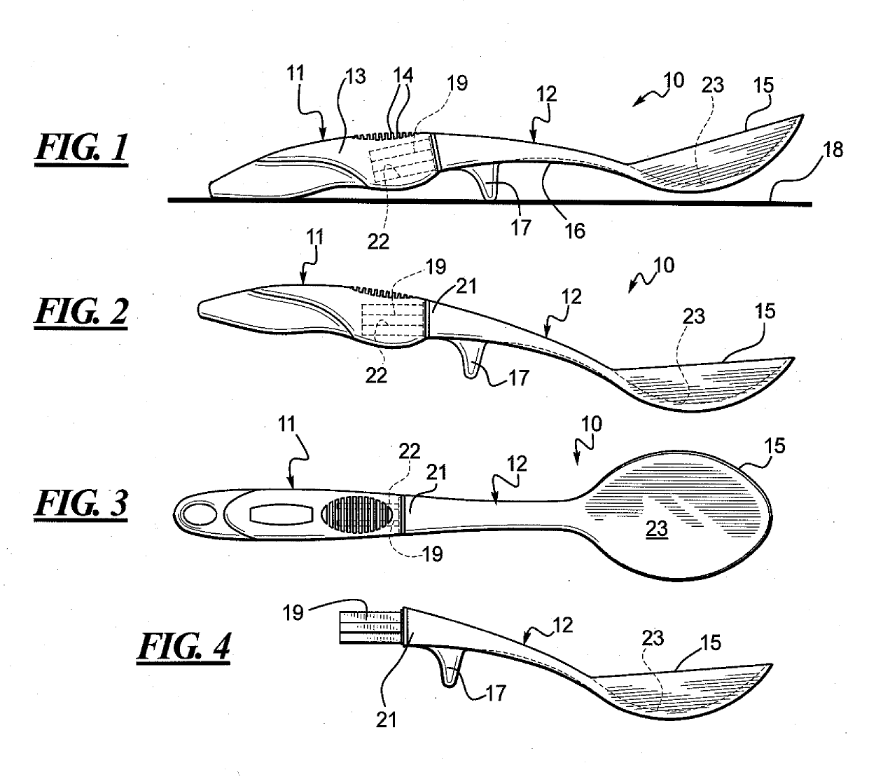

Turning to FIG. 1, a spoon 10 is illustrated which includes a handle portion 11 and a utensil or head portion 12. Preferably, the handle portion 11 and utensil portion 12 are separate embodiments that are connected together by known means, such as a snap fit, glue, fasteners or other conventional means of attachment. The handle portion 11 includes a grip 13 which may include a plurality of transverse ribs shown at 14 on top of grip 14 for improved grip function. The head portion 12 includes a utensil portion 15, in this case a spoon head 15. An underside of the utensil portion 16 includes a supporting member 17 which maintains the spoon head 15 above the counter surface 18 as shown in FIG. 1, when the spoon 10 is in a resting position as shown in FIG. 1.

As shown in FIGS. 1-4, the supporting member 17 may be integrally molded as a part of the utensil portion 12, the grip 13 or may be a separate, integrally attached component. As shown in FIGS. 1-4, the utensil portion 12 includes a shaped shaft 19 at its proximal end 21 (the head portion or spoon portion 15 forming the distal end). The shaft 19 is received within a complimentary shaped aperture 22 in the handle portion 11. In the embodiments shown in FIGS. 1-4, the utensil portion 12 is snap-fitted into the handle portion 11 by way of the shaft 19 and shaped aperture 22.

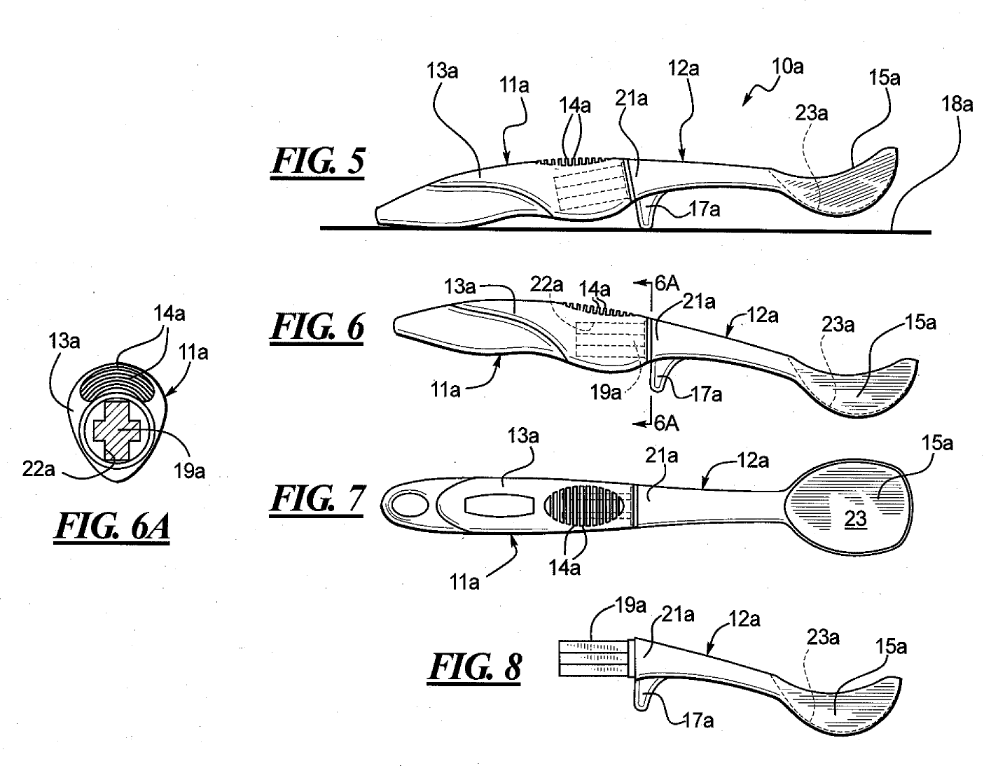

FIGS. 5-8, illustrates another spoon, in this case an ice cream scoop 10a. As shown in FIGS. 5-8, the ice cream scoop 10a includes a separate handle portion 11a and utensil portion 12a. While the structures 11a, 12a are illustrated as separate components, it is also foreseeable that the entire structure of the spoon 10 shown in FIGS. 1-4 or the ice cream scoop 10a shown in FIGS. 5-8 can be integrally molded as a single component.

Still referring to FIGS. 5-8, the scoop or head portion 15a forms the distal end of the utensil portion 12a and a supporting member 17a and shaped shaft 19a are connected to the proximal end 21a of the utensil portion 12a. As shown in FIG. 6A, the handle portion 11a includes an aperture 22a in the shape of a cross which receives the correspondingly shaped shaft 19a. Similar to the embodiments shown in FIGS. 1-4, the grip portion 13a of the handle portion 11a also includes transversely extending ribs 14a for improved gripability. Again the length of the supporting member 17a is sufficient to maintain the head portion 15a above the counter surface 18a when in the resting position as shown in FIG. 5. The supporting member 17a may also be a molded element of the grip 11a.

The supporting member 17 or 17a can also be positioned near the fulcrum point of the entire utensil 10 or 10a whereby the mass or weight of the handle portion 11 or 11a will maintain the head 15 or 15a above the counter surface 18 or 18a even when food or liquid is disposed against the inside wall 23 or 23a of the spoon head 15 or the scoop portion 15a.

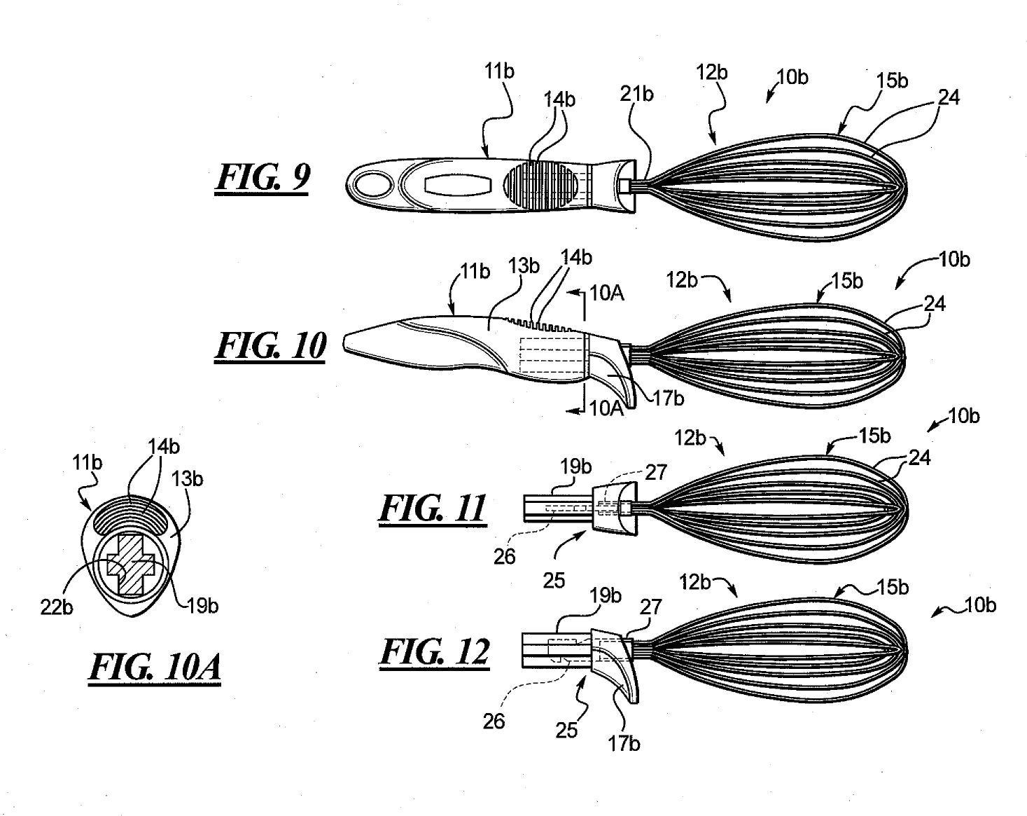

Turning to FIGS. 9-12, yet another utensil 10b is disclosed in the form of a whisk or egg beater. The utensil 10b also include a handle portion 11b connected to a utensil or head portion 12b. The head portion 15b is in the shape of a conventional whisk with the various wires or rods 24 meeting at the proximal end 21b of the utensil portion 12b and being connected to the shaped shaft 19b as shown in FIGS. 11-12. Similar to the embodiments discussed above, the handle portion 11b includes the grip portion 13b, transverse ribs 14b and shaped aperture 22b for receiving the complimentary shaped shaft 19b as shown in FIG. 10A.

Turning to FIGS. 11-12, the shaped shaft 19b is part of a larger connecting element 25 that also includes the supporting member 17b. Specifically, the wires 24 of the head portion 15b are connected to a locking insert 26 by way of a collar 27. The insert 26 is received in the connecting member 25 as shown in FIG. 12. The supporting member 17b is then part of a larger collar element 27 connected to both the shaped shaft 19b, the collar 27 and the shaped insert 26 as shown in FIG. 12. Shown in FIG. 10A, the shaft 19b is received in the shaped aperture 22b of the handle 11b in a manner similar to that as shown above with respect to the embodiment illustrated in FIGS. 5-8. The supporting member 17b may also be a molded element of the group 11b.

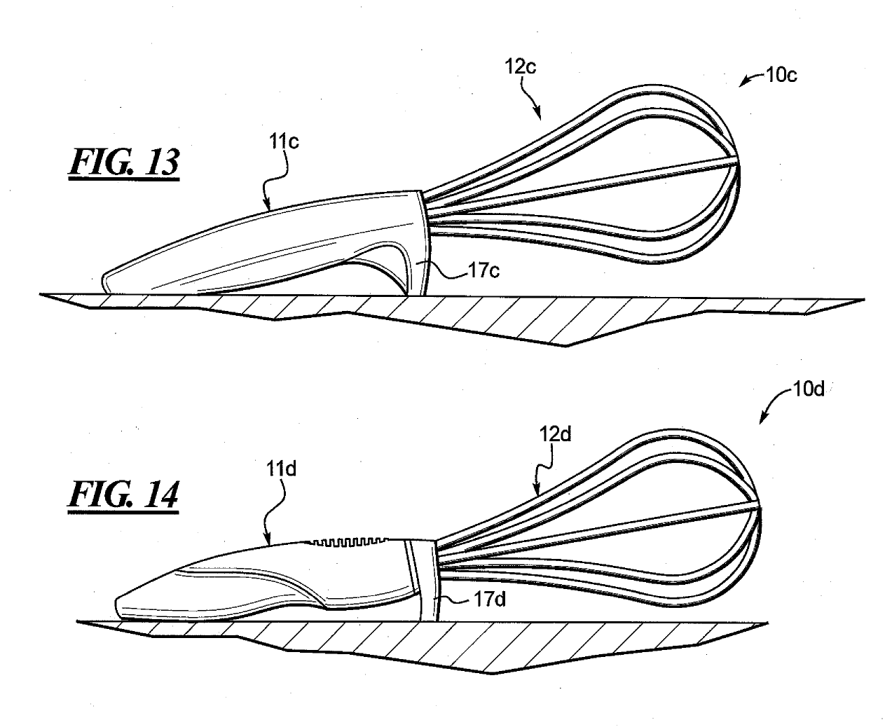

Finally, turning to FIGS. 13-14, alternative embodiments 10c and 10d are illustrated. In FIG. 13, the supporting member 17c is formed as a part of the unitary handle structure 11c which is connected to the head portion 12c in a conventional manner as discussed above with respect to FIGS. 1-12. While, in FIG. 14, the support member 17d is part of a collar disposed between the handle portion 11d and the head portion 12d as shown, the supporting member 17c may also be a part of the grip 11c.

As described above, the disclosed utensils are able to be placed on a counter without the need for a separate spoon rest, plate or napkin because the utensil or head portion is supported above the counter surface or work surface by a disclosed supporting member. Thus, the head or utensil portion will not engage the counter or work surface when placed in the resting position using the supporting member as intended.

Although particular examples of utensils have been disclosed and described herein, the scope of coverage of this disclosure and subsequent patents is not limited thereto. On the contrary, this application is intended to cover all embodiments that fairly fall within the scope of permissible equivalents of the disclosed embodiments.

What is claimed is:

1. A kitchen utensil comprising:
a handle;
a utensil head connected to the handle; and
a supporting member integrally formed as a part of the handle and positioned relative to the handle and the utensil head to support the utensil head above a work surface when the utensil is resting on the work surface with the supporting member borne against the work surface.

2. The kitchen utensil according to claim 1, wherein the utensil head and the handle are connected to one another but can be separated from one another.

3. The kitchen utensil according to claim 1, wherein the utensil head is selected from a group consisting of a spoon head, an ice cream scoop head, and a whisk.

4. The kitchen utensil according to claim 1, wherein the utensil head comprises a distal end having a utensil portion with an underside and an inside wall that faces generally opposite the underside and a proximal end with a shaped shaft that is received in a correspondingly shaped hold in the handle to connect the utensil head to the handle.

5. The kitchen utensil according to claim 1, wherein the supporting member does not project from the head in a direction in which the inside wall faces.

6. The kitchen utensil according to claim 1, wherein the utensil head has a convex underside and a concave inside wall, and wherein the supporting member projects in a direction in which the convex underside of the utensil head faces but does not project in a direction in which the concave inside wall faces.

7. The kitchen utensil according to claim 1, further comprising:
a connecting element that connects the utensil head to the handle.

8. The kitchen utensil according to claim 1, wherein the utensil head is a whisk head with a plurality of wires connected to a collar which is in turn connected to the handle.
